(19) United States
(12) Patent Application Publication
(10) Pub. No.: US 2017/0316734 A1
(43) Pub. Date: Nov. 2, 2017

(54) DISPLAY CONTROL DEVICE, DISPLAY DEVICE, AND DISPLAY CONTROL METHOD

(71) Applicant: Sharp Kabushiki Kaisha, Sakai City, Osaka (JP)

(72) Inventors: Junki ASAI, Sakai City (JP); Hidenori KUWAJIMA, Sakai City (JP)

(21) Appl. No.: 15/529,524

(22) PCT Filed: Dec. 3, 2015
(86) PCT No.: PCT/JP2015/083988

§ 371 Date: May 25, 2017

(30) Foreign Application Priority Data
Dec. 8, 2014 (JP) 2014-248322

(51) Int. Cl. G09G 3/20; G09G 5/395; G09G 3/36; G09G 5/393

(52) U.S. Cl. CPC G09G 3/2096; G09G 5/393; G09G 5/395; G09G 3/3618; G09G 2330/021; G09G 2360/128; G09G 2310/08

(57) ABSTRACT

Electric power consumed in display of image data is suppressed. The present invention includes: a command receiving section (10) which receives, from a host, a command indicative of whether or not an LCD (3) is to be caused to update an image displayed by the LCD (3); and a data processing section (40) carries out at least through-output or writing of the image data in a VRAM (50), with reference to (a) the command and (b) whether or not the image is to be updated in (i) a frame period in which the image data is received or (ii) a frame period coming next to the frame period.

### TECHNICAL FIELD

The present invention relates to a display control device which carries out display control with respect to a display device.

### BACKGROUND ART

A display device, such as a personal computer and a smartphone, generally includes a display controller which carries out various types of display control so that an image is properly displayed on a screen of a display section. The display controller supplies image data, received from a host, to the display device in accordance with a timing at which the display device displays the image. The display controller encompasses (i) a display controller which has therein a memory and (ii) a display controller which does not have a memory. Further, in recent years, a technique of driving the display section at a higher drive frequency has been developed so that a moving image and the like can be displayed with higher quality.

### CITATION LIST

### Patent Literature

[Patent Literature 1]

Japanese Patent Application Publication Tokukai No. 2013-54356 (Publication date: Mar. 21, 2013)

### SUMMARY OF INVENTION

### Technical Problem

Here, in a case where a display controller which has therein a memory as described above controls a display section to be driven at a higher drive frequency, a frequency of access to the memory is increased as a drive frequency at which the display section is driven is increased. This may disadvantageously causes an increase in electric power consumed in display of image data. Meanwhile, in a case where a display controller which does not have a memory controls a display section to be driven at a higher drive frequency, such a display controller transmits/receives image data to/from a host every frame period so as to control the display section to carry out refresh. This similarly may disadvantageously causes an increase in electric power consumed in display of the image data.

The present invention has been made in view of the above problems, and an object of the present invention is to realize a display control device, a display device, and a display control method, each allowing suppression of electric power consumed in display of image data.

### Solution to Problem

In order to attain the above object, a display control device in accordance with an aspect of the present invention is a display control device which receives image data from a host and supplies the image data thus received to a display section, the image data corresponding to 1 (one) frame, the display control device including: an information receiving section which receives, from the host, update information indicative of whether or not the display section is to be caused to update an image displayed by the display section; and a data processing section which, in accordance with the update information, at least writes the image data in a memory or supplies the image data to the display section, wherein, assuming that any one of a first vertical synchronization period, which is a period in which the display control device receives the image data, and a second vertical synchronization period, which is a period coming next to the first vertical synchronization period, is regarded as a given vertical synchronization period, the data processing section supplies the image data to the display section, without writing the image data in the memory, in a case where (i) the display control device receives the image data and (ii) the image is to be updated in the given vertical synchronization period, and the data processing section writes the image data in the memory in a case where (i) the display control device receives the image data and (ii) the image is not to be updated in the given vertical synchronization period.

### Advantageous Effects of Invention

According an aspect of the present invention, it is possible to suppress electric power consumed in display of image data.

### BRIEF DESCRIPTION OF DRAWINGS

FIG. 1 is a block diagram illustrating a configuration of a main part of a display device in accordance with Embodiment 1 of the present invention.

FIG. 2 is a view illustrating systems for input/output of image data in cases where a display control device included in the display device in accordance with Embodiment 1 carries out writing, through-output, and read-output.

FIG. 3 is a timing chart illustrating timings at which various signals and various pieces of data are transmitted/received, which signals and data are related to display control carried out with respect to the display device in accordance with Embodiment 1.

FIG. 4 is a view illustrating a flow of a process carried out by a host and the display control device which are included in the display device in accordance with Embodiment 1.

FIG. 5 is a view illustrating a variation of the timing chart illustrated in FIG. 3.

FIG. 6 is a block diagram illustrating a configuration of a main part of a display device in accordance with Embodiment 2 of the present invention.

FIG. 7 is a timing chart illustrating timings at which various signals and various pieces of data are transmitted/received, which signals and data are related to display control carried out with respect to the display device in accordance with Embodiment 2.

FIG. 8 is a view illustrating a flow of a process carried out by a host and a display control device which are included in the display device in accordance with Embodiment 2.

FIG. 9 is a timing chart illustrating (i) a vertical sync signal and (ii) timings at which pieces of image data are inputted/ outputted, in a display device in accordance with Embodiment 3 of the present invention.

FIG. 10 is a timing chart illustrating timings at which pieces of image data are supplied to/from the display control device, in a case where the display control device delays outputting a vertical sync signal.

### DESCRIPTION OF EMBODIMENTS

### Embodiment 1

The following description will discuss Embodiment 1 of the present invention.

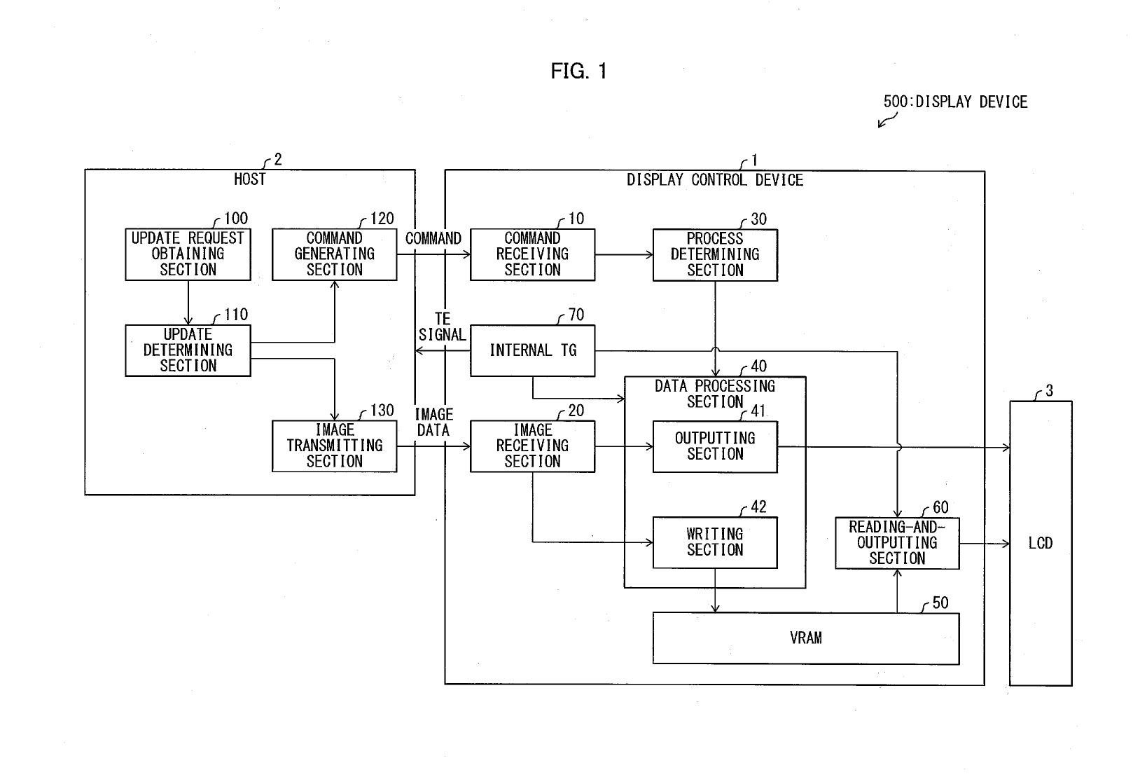

Embodiment 1 of the present invention will be described below in detail. First, a configuration of a display device in accordance with the present invention will be described with reference to FIG. 1.

### Configuration of Main Part

FIG. 1 is a block diagram illustrating a configuration of a main part of a display device 500 in accordance with Embodiment 1. The display device 500 includes a host 2, a display control device 1, and an LCD (display section) 3. Note that the host 2, the display control device 1, and the LCD 3 can be integrated with each other as the display device 500 or can be alternatively respective separate devices.

### Host

The host 2 generates image data which is to be displayed by the LCD 3, and provides the display control device 1 with the image data. Note, here, that the “image data” indicates data on an image which is to be displayed by the LCD 3 and which corresponds to 1 (one) frame. The host 2 transmits the image data to the display control device 1 in synchronization with a TE (Tearing Effect) signal (later described) received from the display control device 1. More specifically, the host 2 includes a command generating section 120, an image transmitting section 130, an update request obtaining section 100, and an update determining section 110.

The update request obtaining section 100 obtains an image update request from application software (hereinafter, simply referred to as an “application”) which is run in the host 2 or in an external device that communicates with the host 2. Note, here, that the “image update request” is a request to update an image, being displayed by the LCD 3 (or image to be displayed by the LCD 3), in a frame period coming next to a frame period in which the image is being displayed (or the image is to displayed). The update request obtaining section 100 transmits, to the update determining section 110, the image update request thus obtained.

The update determining section 110 determines, depending on whether or not the update determining section 110 has received an image update request, (i) a type of a command (update information) which the update determining section 110 causes the command generating section 120 to generate and (ii) image data which the update determining section 110 causes the image transmitting section 130 to transmit. Note, here, that the “command” is a command to be given to the display control device 1 and is generated depending on, as described above, whether or not the update determining section 110 has received an image update request, that is, whether or not the LCD 3 is to update an image. In a case where the update determining section 110 receives an image update request from the update request obtaining section 100, that is, in a case where the LCD 3 is to update an image in a next frame period, the update determining section 110 instructs the command generating section 120 to generate a through command. Note, here, that the “through command” is a command which causes the display control device 1 to supply image data to the LCD 3 without writing the image data in a memory (VRAM 50, later described). The update determining section 110 further instructs the image transmitting section 130 to transmit, to the display control device 1, image data for update of the image. On the other hand, in a case where the update determining section 110 does not receive an image update request from the update request obtaining section 100, that is, in a case where the LCD 3 is not to update an image in a next frame period, the update determining section 110 instructs the command generating section 120 to generate a write command (hereinafter, also referred to as a WR command). Note, here, that the “write command” is a command which causes the display control device 1 to write image data in the memory. The update determining section 110 further instructs the image transmitting section 130 to re-transmit, to the display control device 1, image data which the image transmitting section 130 has transmitted in an immediately preceding frame period.

The command generating section 120 generates a command, and transmits the command to the display control device 1. The command generating section 120 generates a write command or a through command in accordance with an instruction given by the update determining section 110, and transmits the write command or the through command to the display control device 1. The image transmitting section 130 transmits, to the display control device 1, image data in accordance with an instruction given by the update determining section 110. Note that the image transmitting section 130 can generate image data or the image transmitting section 130 can alternatively obtain the image data from, for example, a storage device which is included in the host 2 or which is connected to the host 2 so as to have data communication with the host 2. Note also that a command can be transmitted to the display control device 1 via an interface, such as a DSI, while being superimposed on image data. In this case, a single functional block (interface) into which the command generating section 120 and the image transmitting section 130 are integrated transmits both of the command and the image data.

### Display Control Device

The display control device 1 receives image data from the host 2, and supplies the image data to the LCD 3. More specifically, the display control device 1 is a controller which carries out display control with respect to the whole of the display device 500 by adjusting (i) a timing at which the host 2 supplies image data to the display control device 1 and (ii) a timing at which the LCD 3 displays image data. The display control device 1 includes, more specifically, the VRAM (memory) 50, a command receiving section (information receiving section) 10, an image receiving section 20, a process determining section 30, a data processing section 40, an internal timing generator (internal TG, timing determining section) 70, and a reading-and-outputting section 60.

The VRAM 50 is a memory in which image data is stored. Image data is written in the VRAM 50 by a writing section 42, and is read out by the reading-and-outputting section 60 (later described). Note that the VRAM 50 is not limited to any particular type, provided that image data (or compressed image data) can be stored in the VRAM 50.

The command receiving section 10 receives a command from the command generating section 120 of the host 2. The command receiving section 10 transmits the command thus received to the process determining section 30. The image receiving section 20 receives image data from the image transmitting section 130 of the host 2. Specific examples of the command receiving section 10 and of the image receiving section 20 encompass interfaces each of which is compliant with a DSI (Display Serial Interface) specification out of MIPI (Mobile Industry Processor Interface (Registered trademark)) specifications. The image receiving section 20 transmits the image data thus received to an outputting section 41 and the writing section 42 of the data processing section 40. Note that, in a case where a command is transmitted from the host 2 to the display control device 1 via an interface, such as a DSI, while being superimposed on image data, a single functional block (interface) into which the command receiving section 10 and the image receiving section 20 are integrated receives both of the command and the image data.

The process determining section 30 determines a process which the data processing section 40 is to carry out, in accordance with a type of a command received from the command generating section 120. In a case where the process determining section 30 obtains a through command, the process determining section 30 instructs the data processing section 40 to carry out through-output in a next frame period. Note, here, that the “through-output” means supplying image data to the LCD 3 without writing the image data in the VRAM 50. In a case where the process determining section 30 obtains a write command, the process determining section 30 instructs the data processing section 40 to write image data in the VRAM 50 (writing) in a next frame period.

The data processing section 40 carries out at least any one of such writing and through-output. The data processing section 40 includes (i) the writing section 42 for writing of image data in the VRAM 50 and (ii) the outputting section 41 for through-output. The writing section 42 carries out writing of image data in the VRAM 50 in synchronization with a vertical sync signal which the internal TG 70 (later described) has generated. Note that, in a case where, for example, image data is large in size for a capacity of the VRAM 50, the writing section 42 can compress the image data and then carry out writing. The outputting section 41 carries out through-output of image data received from the image receiving section 20, in synchronization with a vertical sync signal which the internal TG 70 has generated. Note that such through-output does not require access to the memory. Therefore, the outputting section 41 can carry out through-output while the writing section 42 is carrying out writing.

The internal TG 70 generates a vertical sync signal (Vsync) for specifying a timing at which image data is inputted/outputted. The outputting section 41, the writing section 42, and the reading-and-outputting section 60 (later described) carry out through-output, writing, and read-output, respectively, in synchronization with the Vsync which the internal TG 70 has generated. The internal TG 70 further converts, into a TE signal, the Vsync which the internal TG 70 has generated, and transmits the TE signal to the host 2. The TE signal is a signal having two values, that is, a Low level and a High level. The internal TG 70 controls a timing at which the host 2 transmits image data to the display control device 1, by transmitting, to the host 2, the TE signal having a High level or a Low level. The host 2 starts transmitting the image data after a predetermined delay time from a given edge of the TE signal. More specifically, the internal TG 70 transmits the TE signal having a High level during a vertical front porch (VF) period in 1 (one) vertical synchronization period coming after a fall of the Vsync which the internal TG 70 has generated, and transmits the TE signal having a Low level during a period other than the above period.

The reading-and-outputting section 60 carries out read-output. Note, here, that the “read-output” means (i) reading out image data written in the VRAM 50 and (ii) supplying the image data to the LCD 3. The reading-and-outputting section 60 carries out such read-output in accordance with a fall of a Vsync which the internal TG 70 has generated. More specifically, the reading-and-outputting section 60 carries out read-output during a period between (i) an end of a vertical back porch (VB) period starting from the fall of the Vsync and (ii) a start of a VF period of a next vertical sync signal. Note that, in a case where image data written in the VRAM 50 is compressed image data, the reading-and-outputting section 60 can output the image data after uncompressing the image data so that the LCD 3 can display the image data.

### LCD

The LCD 3 displays image data which the LCD 3 has received from the display control device 1 by through-output or read-output. The LCD 3 is preferably a liquid crystal display. Note, however, that the LCD 3 is not limited in configuration, provided that the LCD 3 can display the image data. For example, a display device, other than a liquid crystal display, such as a cathode-ray tube display (CRT), a plasma display, an organic EL (electroluminescence) display, or a field emission display can be employed instead of the LCD 3.

The LCD 3 includes a display screen having a plurality of pixels. The LCD 3 is constituted by, for example, an oxide semiconductor display panel serving as an active matrix display panel. The oxide semiconductor display panel is a display panel in which an oxide semiconductor-TFT (thin film transistor) is used as each switching element provided so as to correspond to one or more of the plurality of pixels, which are two dimensionally arranged. The oxide semiconductor-TFT is a TFT having a semiconductor layer made of an oxide semiconductor. Examples of the oxide semiconductor encompass an oxide semiconductor (InGaZnO-based oxide semiconductor) in which an oxide of indium, gallium, and zinc is used. According to the oxide semiconductor-TFT, an amount of electric current flowing in an on-state is large, and an amount of leak current in an off-state is small. Therefore, by using the oxide semiconductor-TFT for a switching element, it is possible to increase a pixel aperture ratio and to reduce a refresh rate of image display to approximately 1 Hz. A reduction in refresh rate allows a reduction in electric power consumption.

### Details of Process Carried Out by Display Control Device

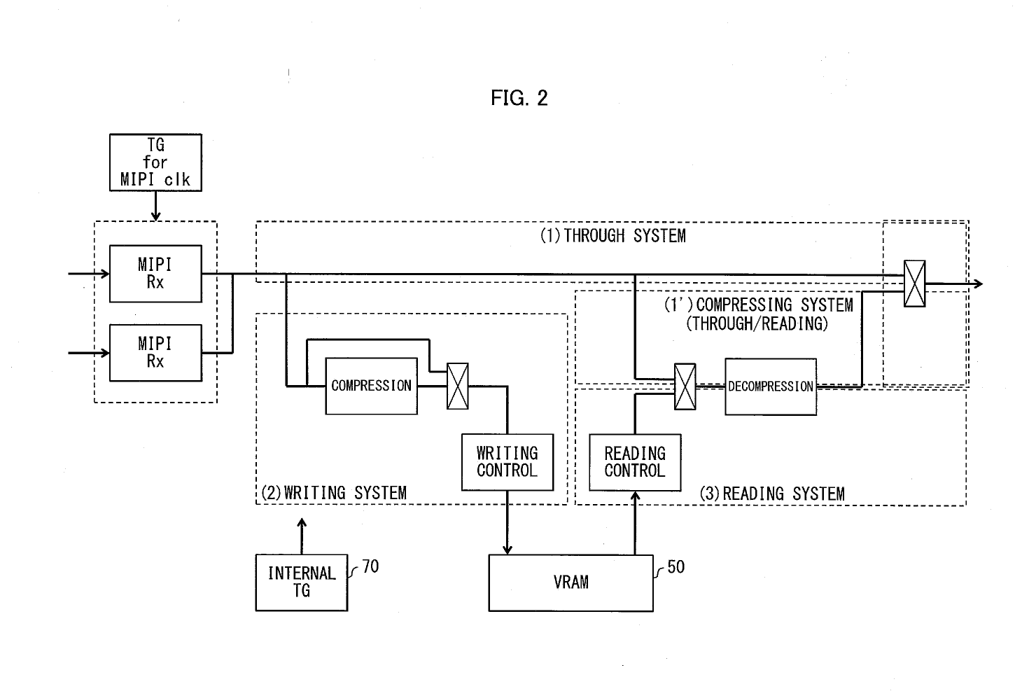

A flow of input/output of image data in each of cases where the display control device 1 carries out writing, through-output, and read-output will be described below in detail with reference to FIG. 2. FIG. 2 is a view illustrating systems for input/output of image data in cases where the display control device 1 carries out writing, through-output, and read-output.

Two “MIPI Rx” blocks illustrated in FIG. 2 are included in the command receiving section 10 and the image receiving section 20, respectively, illustrated in FIG. 1. A “MIPI Rx” block included in the command receiving section 10 receives, with use of a data transfer specification out of the MIPI specifications, a command transferred from the host 2. A “MIPI Rx” block included in the image receiving section 20 receives, with use of a data transfer specification out of the MIPI specifications, image data transferred from the host 2. A “compression” block and a “writing control” block each illustrated in FIG. 2 are included in the writing section 42 illustrated in FIG. 1. A “reading control” block illustrated in FIG. 2 is included in the outputting section 41. A “decompression” block is included in the outputting section 41 and the reading-and-outputting section 60. Note that the “compression” block and the “decompression” block are not essential. A “TG for MIPI clk” block extracts, in accordance with both of the two “MIPI Rx” blocks, timing information on image data, and transmits the timing information to a through-outputting section.

As illustrated in FIG. 2, the display control device 1 processes image data with use of at least any one of (1) a through system, (2) a writing system, and (3) a reading system. Note that the through system and the reading system can partially share a system ((1′) through/reading system).

### Through System

The through system is a system which carries out through-output of image data which the display control device 1 (image receiving section 20) has received from the host 2. In a case where a command which the display control device 1 has received from the host 2 is a through command, the through system processes image data.

Specifically, the outputting section 41 of the data processing section 40 supplies, to the LCD 3, image data received via the MIPI Rx (image receiving section 20), in synchronization with timing information which the TG for MIPI clk has extracted (through-output). Note that, in a case where image data received from the host 2 is compressed data, the outputting section 41 (i) decompresses the image data via the (1′) through/reading system and (ii) supplies, to the LCD 3, the image data thus decompressed (see FIG. 2). The through system is a processing system which does not access the VRAM 50 (see FIG. 2). Therefore, it is possible to for the through system and the writing system (later described) can carry out respective processes in parallel.

### Writing System

The writing system is a system which carries out writing of image data in the VRAM 50 which image data the display control device 1 has received from the host 2. In a case where a command which the display control device 1 has received from the host 2 is a WR command, the writing system processes image data.

Specifically, the writing section 42 of the data processing section 40 writes, in the VRAM 50, image data received via the MIPI Rx (image receiving section 20), in synchronization with a Vsync which the internal TG 70 has generated (“writing control” block). Note that the writing section 42 can compress the image data (“compression” block) and write, in the VRAM 50, the image data thus compressed.

### Reading System

Each of (1) the through system and (2) the writing system starts a process upon receipt of a command and image data from the host 2. Unlike the (1) through system and (2) the writing system, (3) the reading system is a processing system which carries out a process in a case where a command, indicative of update of an image, and image data are not supplied from the host 2 by a start of a vertical synchronization period of the LCD 3.

Specifically, the reading-and-outputting section 60 reads out image data from the VRAM 50 (“reading control” block), decompresses the image data as necessary (“decompression” block), and supplies the image data to the LCD 3. In so doing, the reading-and-outputting section 60 reads out the image data from the VRAM 50 in synchronization with a Vsync which the internal TG 70 has generated. The reading-and-outputting section 60 then supplies, to the LCD 3, the image data thus read out, in synchronization with the Vsync.

Note that, in a case where the update request obtaining section 100 of the host 2 of the display device 500 does not obtain an image update request from an application by the start of the vertical synchronization period of the LCD 3, the update determining section 110 can cause the command generating section 120 to, in a next frame period, generate and transmit a command which indicates that an image is not to be updated (update information which indicates that an image is not to be updated). In this case, the command receiving section 10 of the display control device 1 transmits the command to the process determining section 30, and the process determining section 30 instructs the reading-and-outputting section 60 to carry out read-output. The reading-and-outputting section 60 thus carries out read-output.

### Example Control Carried Out in Display Device

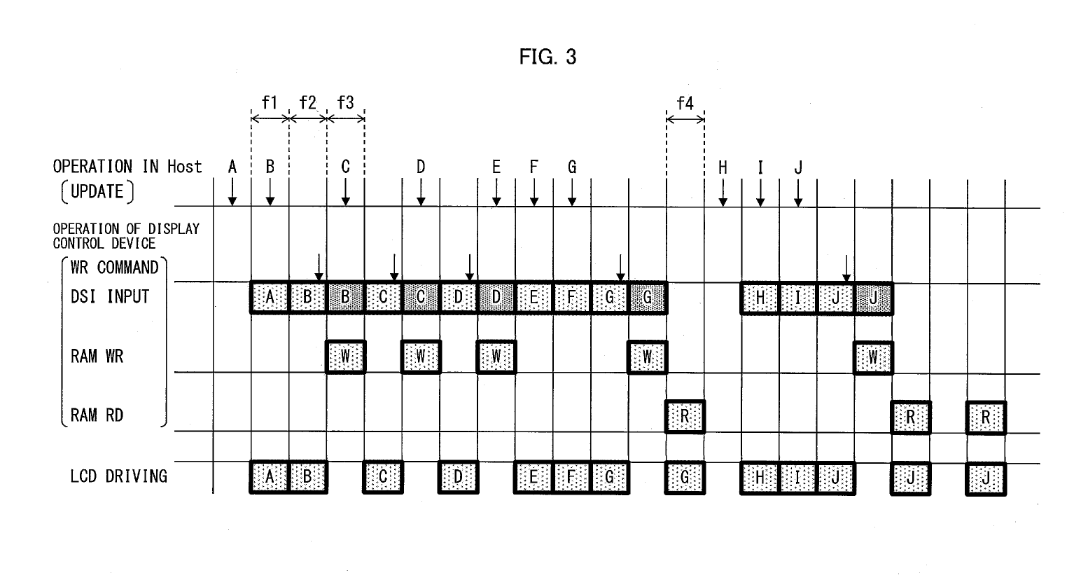

Next, a flow of a display control process carried out by the display device 500 (in particular, the host 2 and the display control device 1) will be described below with reference to FIG. 3. FIG. 3 is a timing chart illustrating timings at which various signals and various pieces of data are transmitted/received, which signals and data are related to display control carried out with respect to the display device 500. A single column illustrated in FIG. 3 indicates 1 (one) frame period defined by the display control device 1.

An “update” row indicates, with or without use of a downward arrow, whether or not the update request obtaining section 100 has obtained an image update request from an application in each frame period. A “WR command” row indicates, with use of a downward arrow, a timing at which the command receiving section 10 of the display control device 1 receives a WR command. A “DSI input” row indicates a timing and a period at/during which the image receiving section 20, which is an interface compliant with the DSI specification, receives image data (image data is supplied from the host 2 to the image receiving section 20).

In the “DSI input” row, each block designated by an alphabet indicates image data, and blocks designated by respective identical alphabets indicate identical image data. FIG. 3 illustrates, for convenience, a period during which the image receiving section 20 receives image data, as if the period were identical in length to 1 (one) frame period. Note, however, that image data is actually received (transferred) during a period shorter than 1 (one) frame period.

A “RAM WR” row indicates, with use of a block designated by an alphabet “W,” a timing and a period at/during which the writing section 42 of the display control device 1 carries out writing of image data in the VRAM 50. A “RAM RD” row indicates, with use of a block designated by an alphabet “R,” a timing and a period at/during which the reading-and-outputting section 60 reads out image data from the VRAM 50. FIG. 3 illustrates, for convenience, a “W” block or an “R” block as if the “W” block or the “R” block were identical in length to 1 (one) frame period. Note, however, that image data is actually written or read out during a period shorter than 1 (one) frame period. An “LCD driving” row indicates a timing at which the LCD 3 is driven, that is, (i) a timing at which the LCD 3 displays image data and (ii) a period during which the LCD 3 updates an image. FIG. 3 illustrates, for convenience, a period during which the LCD 3 updates an image, as if the period is identical in length to 1 (one) frame period. Note, however, that it is not necessary that the period be identical in length to 1 (one) frame period.

As illustrated in FIG. 3, the update request obtaining section 100 attempts to obtain, in each frame period, an image update request from an application. Here, in a case where the update request obtaining section 100 obtains an image update request from an application in a frame period, the update determining section 110 which has received the image update request from the update request obtaining section 100 determines that the LCD 3 needs to update an image in a frame period coming next to the frame period, and gives the command generating section 120 and the image transmitting section 130 respective instructions. This causes (i) the command generating section 120 to generate a through command and transmit the through command to the command receiving section 10 and (ii) the image transmitting section 130 to transmit image data (for update) to the image receiving section 20. In so doing, the host 2 stores, for example, in a storage device or the like (not illustrated), the image data which the host 2 has transmitted (hereinafter, referred to as transmitted image data).

Specifically, the update request obtaining section 100 obtains an image update request, for example, in a frame period f1 illustrated in FIG. 3 (arrow B in the “update” row). Therefore, the command generating section 120 transmits a through command to the command receiving section 10 of the display control device 1. Meanwhile, in a frame period coming next to the frame period f1, the image transmitting section 130 transmits, to the image receiving section 20, image data B for update, and the image receiving section 20 receives the image data B (the “DSI input” row in f2). In so doing, the host 2 stores, in a storage device or the like (not illustrated), the image data B which the host 2 has transmitted.

In other words, in a case where (i) the display control device 1 receives the image data B and (ii) an image is to be updated in a vertical synchronization period f2 (first vertical synchronization period) in which the display control device 1 finishes receiving the image data B, the data processing section 40 supplies the image data B to the LCD 3 without writing the image data B in the VRAM 50 (the “LCD driving” row in f2).

The command generating section 120 transmits the through command thus received to the process determining section 30. The process determining section 30 instructs, in accordance with a type of such a command, the data processing section 40 to carry out through-output. The outputting section 41 of the data processing section 40 carries out through-output of the image data B in accordance with such an instruction. This consequently allows the LCD 3 to display the image data B without causing image data to be written in the VRAM 50 and without causing image data to be read out from the VRAM 50 (the “LCD driving” row in f2).

On the other hand, in a case where an image update request from an application ceases in a frame period, the update determining section 110 determines that an image is not to be updated in a frame period coming next to the frame period, and gives the command generating section 120 and the image transmitting section 130 respective instructions. This causes (i) the command generating section 120 to generate a write command and transmit the write command to the command receiving section 10 and (ii) the image transmitting section 130 to read out transmitted image data, which the host 2 has stored, and re-transmit the transmitted image data to the image receiving section 20 of the display control device 1.

For example, the update request obtaining section 100 does not obtain an image update request in the frame period f2 illustrated in FIG. 3 (blank in the “update” row in f2). Therefore, the command generating section 120 transmits a write command to the command receiving section 10 (arrow in the “WR command” row in f2). Meanwhile, the image transmitting section 130 re-transmits, to the display control device 1, transmitted image data (image data B) by an end of a frame period f3 (the “DSI input” row in f3). The command receiving section 10 which has received the write command transmits the write command to the process determining section 30. The process determining section 30 instructs the data processing section 40 to carries out writing of such transmitted image data B in the VRAM 50 in f3. The writing section 42 of the data processing section 40 writes the transmitted image data B in the VRAM 50 in the frame period f3 in accordance with such an instruction (the “RAM WR” row in f3).

In other words, in a case where (i) the display control device 1 re-receives the transmitted image data B and (ii) an image is not to be updated in a vertical synchronization period f3 (first vertical synchronization period) in which the display control device 1 finishes re-receiving the transmitted image data B, the data processing section 40 writes the transmitted image data B in the VRAM 50 without supplying the transmitted image data B to the LCD 3.

It is assumed that, in a state where a write command, indicative of update of an image, and image data are not supplied to the display control device 1, a given frame period has elapsed since image data was finally supplied to the LCD 3. In this case, the reading-and-outputting section 60 of the display control device 1 is driven so as to read out transmitted image data from the VRAM 50. For example, assuming that the “given frame period” is 1 (one) frame period, the given frame period has elapsed in f4 illustrated in FIG. 3. In this case, image data G which has been written in the VRAM 50 in a frame period coming before f4 is stored in the VRAM 50. Therefore, the reading-and-outputting section 60 reads out the image data G from the VRAM 50 (“RAM RD” row in f4), and supplies the image data G to the LCD 3 (the “LCD output” row in f4).

The display device 500 thus switches among through-output, writing, and read-output for each frame depending on (i) whether or not an image update request has been obtained by the display control device 1 and (ii) whether or not a given frame period has elapsed. This makes it possible to supply image data to the LCD 3 without accessing the VRAM 50, in a case where an image is to be updated. Furthermore, in a case where update of an image has stopped, it is possible to re-transmit transmitted image data to the display control device 1 and write such re-transmitted image data in the VRAM 50. Moreover, in a case where (i) update of an image has stopped and (ii) the LCD 3 needs to carry out refresh, it is possible to cause the LCD 3 to display transmitted image data (possible to cause the LCD 3 to refresh display) by the reading-and-outputting section 60 carrying out read-output, even without operation of the host 2. For example, it is possible to maintain display quality by carrying out refresh at 60 Hz at the lowest. Besides, according to a display panel which employs oxide semiconductor-TFTs, it is possible to reduce a refresh rate to approximately 1 Hz while maintaining display quality. In this case, it is possible to set the foregoing given frame period to, for example 59 frame periods.

### Flow of Process Carried Out by Each of Host and Display Control Device

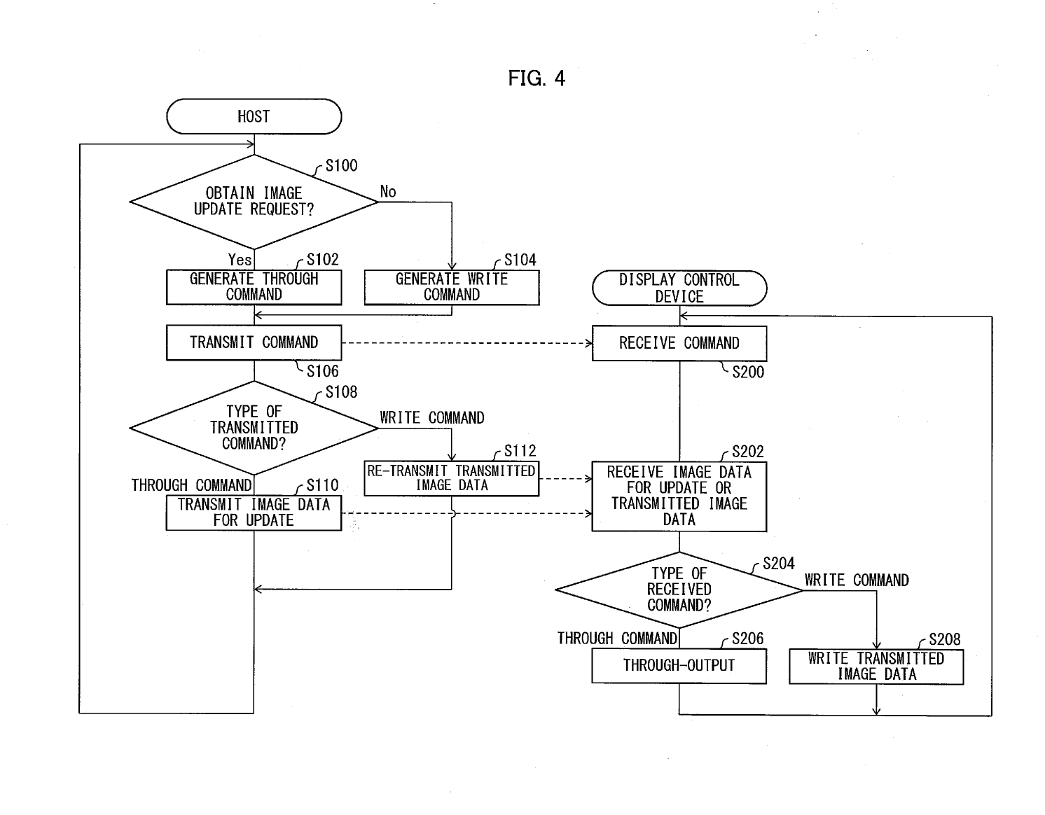

Lastly, a flow of a process of switching between through-output and writing, which process is carried out in the above example control illustrated in FIG. 3, will be described below with reference to FIG. 4. FIG. 4 is a view illustrating a flow of a process of determining which one of through-output and writing to be carried out, which process is carried out by the host 2 and the display control device 1 in the example control illustrated in FIG. 3.

In a case where the update request obtaining section 100 of the host 2 obtains an image update request from an application in 1 (one) frame period (YES, in S100), the update determining section 110 causes the command generating section 120 to generate a through command (S102). In a case where the update request obtaining section 100 does not obtain an image update request in 1 (one) frame period (NO, in S100), the update determining section 110 causes the command generating section 120 to generate a write command (S104). The command generating section 120 transmits a command thus generated to the command receiving section 10 of the display control device 1 (S106). The command receiving section 10 receives the command (S200, information receiving step), and transmits the command to the process determining section 30.

Meanwhile, the update determining section 110 causes the image transmitting section 130 to transmit image data in accordance with a type of the command transmitted to the command receiving section 10. In a case where the command is a through command (S108), the update determining section 110 causes the image transmitting section 130 to transmit image data for update (S110). In a case where the command is a write command (S108), the update determining section 110 causes the image transmitting section 130 to re-transmit transmitted image data (S112).

In a case where the image receiving section 20 of the display control device 1 receives (i) the image data for update or (ii) the transmitted image data (S202), the image receiving section 20 transmits, to the data processing section 40, (i) the image data for update or (ii) the transmitted image data. The data processing section 40 processes such received image data in accordance with an instruction given by the process determining section 30. That is, in a case where the command which the command receiving section 10 has received from the host 2 is a through command (S204), the outputting section 41 of the data processing section 40 carries out through-output (S206, data processing step). In a case where the command which the command receiving section 10 has received from the host 2 is a write command (S204), the writing section 42 carries out writing of the transmitted image data in the VRAM 50 (S208, data processing step).

### Variation of Display Control

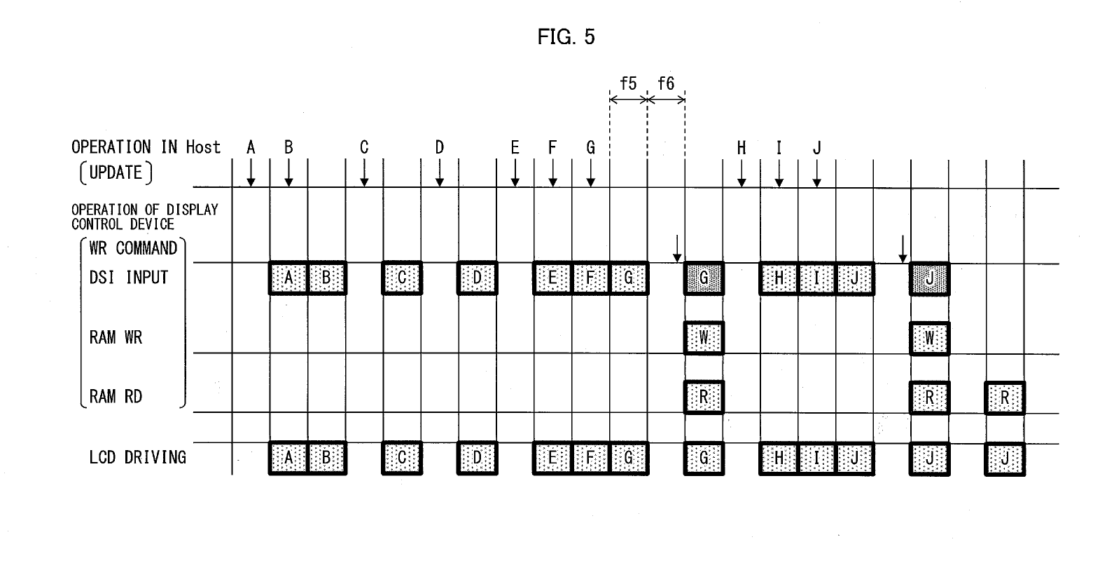

According to FIG. 3 and the description thereof, the host 2 is arranged such that, in a case where the update request obtaining section 100 does not obtain an image update request from an application in a frame, the image transmitting section 130 immediately transmits transmitted image data to the display control device 1. Alternatively, the host 2 can be arranged such that, in a case where (i) the LCD 3 is a device which can change a frame rate and (ii) the update request obtaining section 100 does not obtain an image update request, the image transmitting section 130 re-transmits transmitted image data to the display control device 1 at any timing in a period corresponding to 1 (one) frame at the lowest frame rate of the LCD 3, instead of immediately transmitting the transmitted image data to the display control device 1. A variation of the example control illustrated in FIG. 3 will be described below with reference FIG. 5. Note that, out of processes illustrated in FIG. 5, processes similar to those illustrated in FIG. 3 will not be described below. FIG. 5 is a view illustrating a variation of the timing chart illustrated in FIG. 3.

An LCD 3 of the present variation is a device which can change a refresh rate. Specifically, it is preferable that the LCD 3 can change a frame rate from a low frequency of approximately 1 Hz to a high frequency of approximately 120 Hz. Note that FIG. 5 illustrates, as an example, a case where the LCD 3 is normally driven at a refresh rate of 120 Hz and the lowest refresh rate is 60 Hz.

In a case where an image update request from an application ceases in a frame period (for example, in f5 illustrated in FIG. 5), an update determining section 110 determines that an image is not to be updated in a frame period coming next to the frame period. The update determining section 110 then stands by for a period corresponding to 1 (one) frame at the predetermined lowest frame rate (60 Hz) of the LCD 3 (that is, for a maximum period of an interval between refreshes during which maximum period the LCD 3 can be driven). The update determining section 110 instructs an image transmitting section 130 to transmit transmitted image data to a display control device 1, when approximately 1/60 seconds (maximum refresh cycle) has elapsed since the image transmitting section 130 started transmitting image data last time. According to an example illustrated in FIG. 5, the LCD 3 is driven in accordance with a vertical sync signal of 120 Hz, and the lowest frame rate is 60 Hz. Therefore, the update determining section 110 stands by for 1 (one) frame period coming next to f5. In a case where the update determining section 110 receives an image update request, which has been obtained from an application, while the update determining section 110 is standing by, the update determining section 110 instructs a command generating section 120 to generate a through command, and instructs an image transmitting section 130 to transmit image data for update. In a case where the update determining section 110 does not receive an image update request while the update determining section 110 is standing by, the update determining section 110 instructs the command generating section 120 to generate a write command, and instructs the image transmitting section 130 to transmit transmitted image data to the display control device 1. For example, the update request obtaining section 100 does not obtain an image update request in f6 which is a frame period coming next to f5. Therefore, the command generating section 120 generates a write command (a “WR command” row in f6). Meanwhile, the image transmitting section 130 re-transmits transmitted image data (image data G) to the display control device 1. A writing section 42 of the display control device 1 then carries out writing of the transmitted image data (image data G) in a VRAM 50 (a “RAM WR” row in f6).

Note that it has been described that the update determining section 110 gives the command generating section 120 and the image transmitting section 130 respective instructions, when a period, corresponding to 1 (one) frame at the lowest frame rate of the LCD 3, has elapsed. Alternatively, the host 2 can be arranged such that (i) the update determining section 110 gives the command generating section 120 and the image transmitting section 130 respective instructions similar to those described with reference to FIG. 3 and (ii) each of the command generating section 120 and the image transmitting section 130 stands by, without generating a command or without transmitting transmitted image data, until a period, corresponding to 1 (one) frame at the lowest frame rate of the LCD 3, elapses. Furthermore, in a case where, for example, the lowest refresh rate of the LCD 3 is 1 Hz, the image transmitting section 130 can transmit transmitted image data when 1 second (maximum refresh cycle) has elapsed since the image transmitting section 130 started transmitting image data last time.

### Embodiment 2

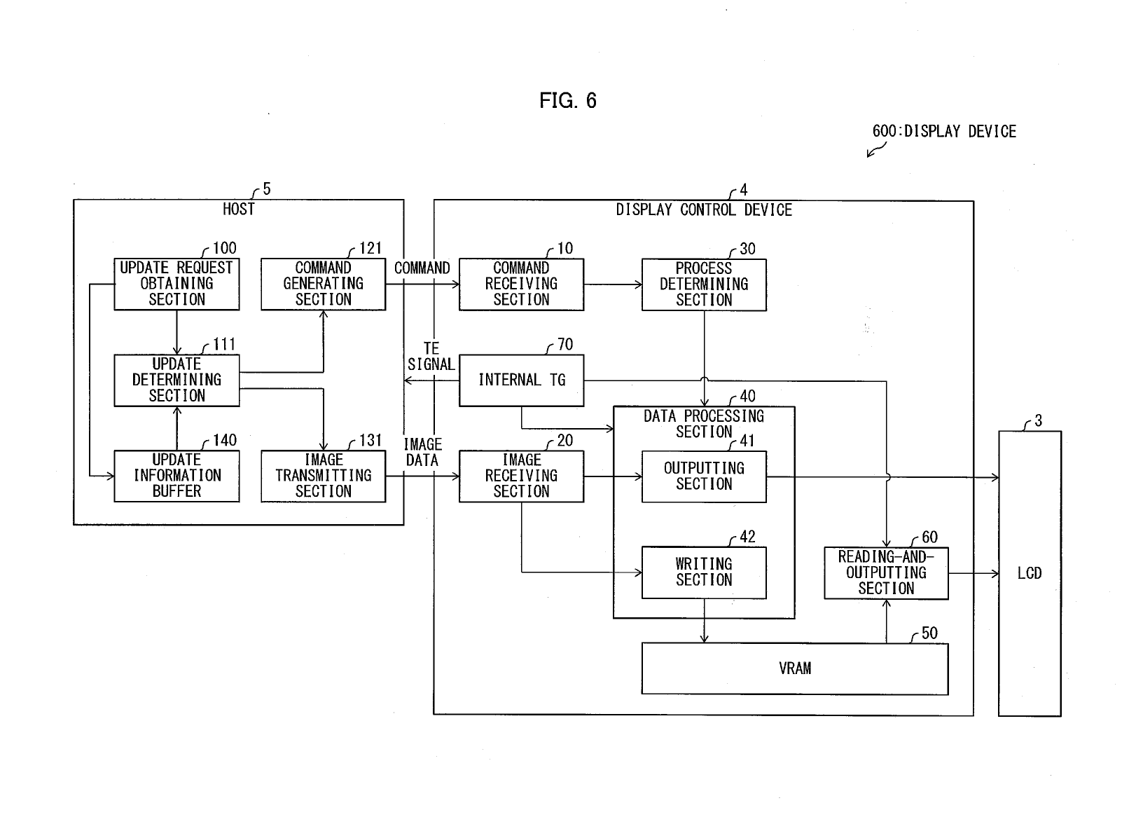

The following description will discuss Embodiment 2 of the present invention with reference to FIGS. 6 through 8. Note that, for convenience, members identical in function to the respective members described in Embodiment 1 will be given respective identical reference numerals and will not be described below.

### Configuration of Main Part

FIG. 6 is a view illustrating a configuration of a main part of a display device 600 in accordance with Embodiment 2. As illustrated in FIG. 6, the display device 600 includes a host 5, a display control device 4, and an LCD 3. The host 5 is different from the host 2 in accordance with Embodiment 1 in that the host 5 includes an update information buffer 140. The update information buffer 140 stores therein (i) one or more pieces of information each indicating whether or not an update request obtaining section 100 has obtained an image update request in a corresponding given frame period and (ii) one or more image update requests each obtained in a corresponding given frame period, in a case where the update request obtaining section 100 has obtained the one or more image update requests. The update information buffer 140 stores therein at least one piece of information indicating whether or not the update request obtaining section 100 has obtained an image update request, the at least one piece of information corresponding to 1 (one) frame. The host 2 sequentially reads out an image update request stored in the update information buffer 140, and transfers image data in accordance with the image update request thus read out (that is, causes the LCD 3 to update an image).

An update determining section 111 in accordance with Embodiment 2 determines instructions to be given to a command generating section 121 and an image transmitting section 131, respectively, in accordance with (i) whether or not the update request obtaining section 100 obtained an image update request in a frame period coming immediately before a current frame period and (ii) whether or not the update request obtaining section 100 has obtained an image update request in the current frame period. Specifically, the update determining section 111 first determines, with reference to the update information buffer 140, whether or not the update request obtaining section 100 obtained an image update request in a frame period coming immediately before a current frame period. In a case where information, indicating that the update request obtaining section 100 obtained an image update request in the frame period coming immediately before the current frame period, is stored in the update information buffer 140, the update determining section 111 instructs the image transmitting section 131 to transmit, to the display control device 4, image data for update. That is, the update determining section 111 instructs the image transmitting section 131 to transmit the image data, in accordance with not an image update request which the update request obtaining section 100 has obtained in the current frame period, but the image update request which the update request obtaining section 100 obtained in the frame period coming immediately before frame period. In other words, the update determining section 111 processes the image update request after a delay of 1 (one) frame period. The update determining section 111 further determines whether or not an image is to be updated in the current frame period, in accordance with whether or not the update determining section 111 has received, from the update request obtaining section 100, an image update request which the update request obtaining section 100 has obtained in the current frame period (image update request to be stored in the update information buffer 140). In a case where the update determining section 111 has received an image update request from the update request obtaining section 100, that is, in a case where the update determining section 111 has received an image update request from the update request obtaining section 100 in each of the current frame period and the frame period coming immediately before the current frame period, the update determining section 111 instructs the command generating section 121 to generate a through command. In a case where (i) information, indicating that the update request obtaining section 100 obtained an image update request in the frame period coming immediately before the current frame, is stored in the update information buffer 140 but (ii) the update determining section 111 has not received an image update request from the update request obtaining section 100, that is, in a case where (i) the update request obtaining section 100 obtained an image update request in the frame period coming immediately before the current frame period and stored the image update request in the update information buffer 140 but (ii) the update request obtaining section 100 has not obtained an image update request in the current frame period, the update determining section 111 instructs the command generating section 121 to generate a write-and-through command. Note, here, that the “write-and-through command” is a command which causes the display control device 4 to carry out both writing of image data in a VRAM 50 and through-output. In accordance with such an instruction given by the update determining section 111, the command generating section 121 generates a write-and-through command and transmits the write-and-through command to the display control device 4. Note that, in a case where information, indicating that the update request obtaining section 100 did not obtain an image update request in the frame period coming immediately before the current frame, is stored in the update information buffer 140, that is, in a case where the update determining section 111 did not obtain an image update request in the frame period coming immediately before the current frame period, the update determining section 111 stands by, without giving the command generating section 121 and the image transmitting section 131 respective instructions, until a frame period coming next to the current frame period.

### Example Control Carried Out with Respect Display Device

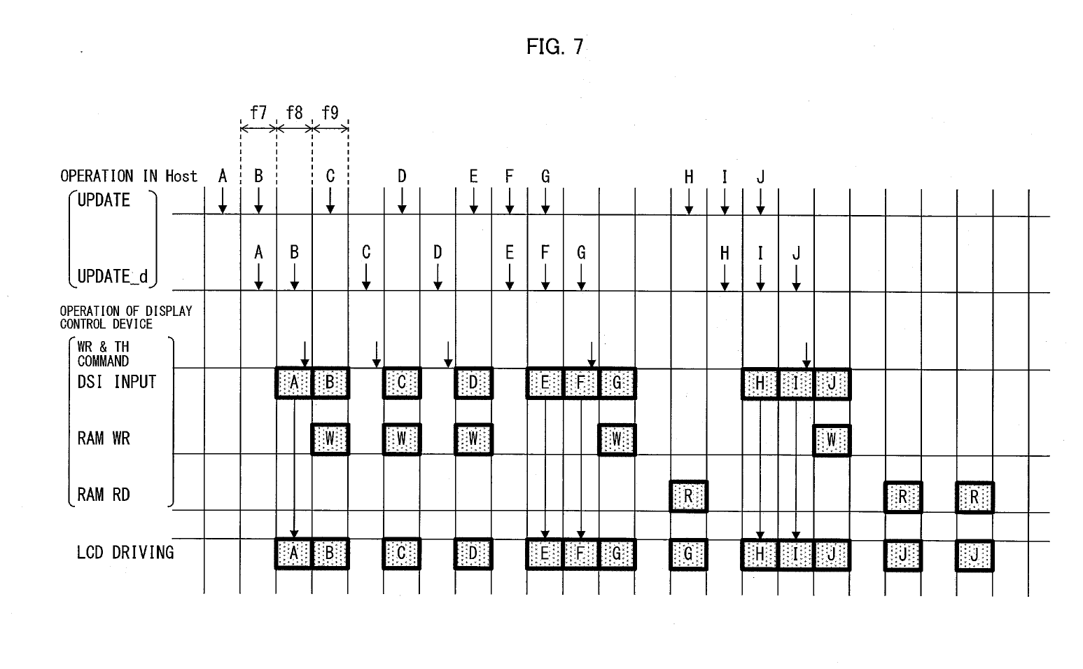

Next, a display control process carried out by display device 600 will be described below with reference to FIG. 7. FIG. 7 is a timing chart illustrating timings at which various signals and various pieces of data are transmitted/received, which signals and data are related to display control carried out with respect to the display device 600. Note that, out of processes illustrated in FIG. 7, processes similar to those illustrated in FIG. 3 will not be described below.

An “update” row illustrated in FIG. 7 indicates, with or without use of a downward arrow, whether or not the update request obtaining section 100 has obtained an image update request from an application in each frame period. An “update_d” row indicates, with or without use of a downward arrow, whether or not the update determining section 111 has read out an image update request from the update information buffer 140. A “WR & TH command” row indicates, with use of a downward arrow, a timing at which a command receiving section 10 of the display control device 4 receives a write-and-through command.

It is found, from, for example, a frame period f7 illustrated in FIG. 7, that the update request obtaining section 100 obtains an image update request in each of a current frame period and a frame period coming immediately before the current frame period (the “update” row and the “update_d” row in f7). In this case, the update determining section 111 causes the command generating section 121 to generate a through command and transmit the through command thus generated to the display control device 4. Meanwhile, in accordance with the image update request obtained in the frame period coming before the current frame period, the update determining section 111 causes the image transmitting section 131 to transmit, in a frame period coming next to the current frame period, image data A, which is to be supplied to the LCD 3 (to be used to update an image) in the frame period coming next to the current frame period, to the display control device 4. An image receiving section 20 of the display control device 4 finishes receiving the image data A and the command receiving section 10 receives the through command, by an end of a frame period f8 (a “DSI input” row in f8). A process determining section 30 causes, in accordance with the through command received from the command receiving section 10, a data processing section 40 to carry out through-output in the frame period f8 (an “LCD driving” row in f8).

In other words, in a case where (i) the display control device 4 receives the image data A and (ii) the image is to be updated in a vertical synchronization period f9 (second vertical synchronization period) coming next to a vertical synchronization period f8 in which the display control device 4 finishes receiving the image data A, the data processing section 40 supplies the image data A to the LCD 3 without writing the image data A in the VRAM 50. As illustrated in FIG. 7, the image update request which the update request obtaining section 100 has obtained in the frame period (f7) coming before f8 (an arrow B in the “update” row in f7) is stored in the update information buffer 140, and is read out by the update determining section 111 in the frame period f8 (an arrow B in the “update_d” row). The update determining section 111 then gives the command generating section 121 and the image transmitting section 131 respective instructions in accordance with the image update request thus read out. Accordingly, the display control device 4 which has received, by an end of a frame period f9, (i) a command from the command generating section 121 and (ii) image data from the image transmitting section 131 causes an image to be updated in the frame period f9. Therefore, in the frame period f9, the data processing section 40 supplies the image data A to the LCD 3 without writing the image data A in the VRAM 50.

Meanwhile, according to, for example, the frame period f8 illustrated in FIG. 7, the update request obtaining section 100 obtains the image update request in the frame period coming immediately before the frame period f8, but the update request obtaining section 100 does not obtain an image update request in a current frame period (the “update” row and the “update_d” row in f8). In this case, the update determining section 111 causes the command generating section 121 to generate a write-and-through command and transmit the write-and-through command thus generated to the display control device 4. Meanwhile, in accordance with the image update request obtained in the frame period coming immediately before the current frame period, the update determining section 111 causes the image transmitting section 131 to transmit the image data B for update in the frame period f9. The command receiving section 10 of the display control device 4 receives the write-and-through command (the “WR & TH command” row in f9). Meanwhile, the image receiving section 20 receives the image data B (the “DSI input” row in f9). Upon receipt of the write-and-through command from the command receiving section 10, the process determining section 30 causes the data processing section 40 to carry out both writing of the image data A in the VRAM 50 (a “RAM WR” row in f9) and through-output (an “LCD driving” row in f9).

In other words, in a case where (i) the display control device 4 receives the image data B and (ii) an image is not to be updated in a vertical synchronization period (second vertical synchronization period) coming next to the vertical synchronization period f9 in which the display control device 4 finishes receiving the image data B, the data processing section 40 supplies the image data B to the LCD 3 and writes the image data B in the VRAM 50.

### Flow of Process Carried Out by Each of Host and Display Control Device

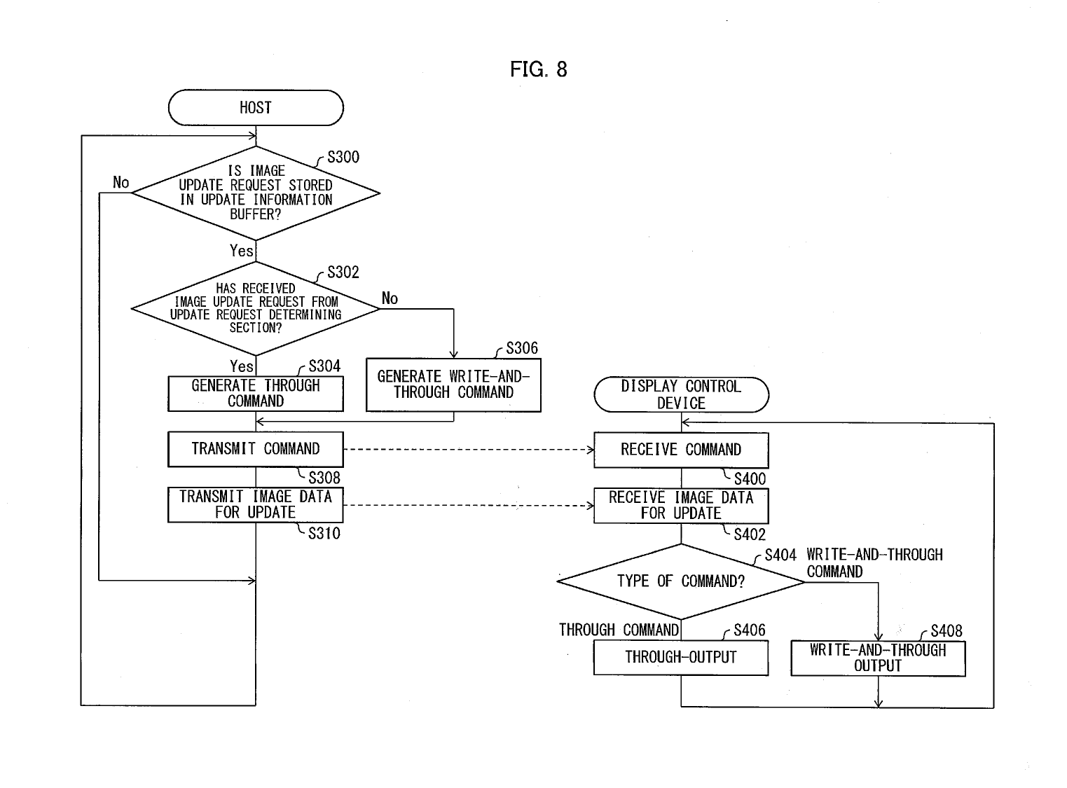

Lastly, a flow of a process of switching between through-output and writing, which process is carried out in the above example control illustrated in FIG. 7, will be described below with reference to FIG. 8. FIG. 8 is a flowchart illustrating a flow of a process of determining which one of through-output and write-and-through-output to be carried out, which process is carried out by the host 5 and the display control device 4 in the example control illustrated in FIG. 7.

In a case where the update request obtaining section 100 of the host 5 obtains an image update request from an application, the update request obtaining section 100 stores the image update request in the update information buffer 140 and transmit the image update request to the update determining section 111. The update determining section 111 determines, with reference to the update information buffer 140, whether or not the update request obtaining section 100 obtained an image update request in a frame period coming immediately before a current frame period (S300). In a case where the update request obtaining section 100 obtained an image update request in the frame period coming immediately before the current frame period (YES, in S300), the update determining section 111 instructs the image transmitting section 131 to transmit image data for update, and further determines whether or not the update determining section 111 has received an image update request from the update request obtaining section 100 (that is, whether or not the update request obtaining section 100 has obtained an image update request from the application in the current frame period) (S302). Note that, in a case where the update request obtaining section 100 did not obtain an image update request in the frame period coming immediately before the current frame period (NO, in S300), the update request obtaining section 100 stores, in the update information buffer 140, information indicating whether or not the update request obtaining section 100 obtained an image update request in the current frame period, and the update determining section 111 stands by until a frame period coming next to the current frame period. In a case where (i) the update request obtaining section 100 obtained an image update request in the frame period coming immediately before the current frame period (YES, in S300) and (ii) the update determining section 111 has received an image update request from the update request obtaining section 100 (YES, in S302), the update determining section 111 instructs the command generating section 121 to generate a through command, and the command generating section 121 generates a through command (S304). In a case where the update determining section 111 has not received an image update request from the update request obtaining section 100 (NO, in S302), the update determining section 111 instructs the command generating section 121 to generate a write-and-through command, and the command generating section 121 generates a write-and-through command (S306). The command generating section 121 transmits such a command thus generated to the image receiving section 20 of the display control device 4 (S308). Meanwhile, in accordance with an instruction given by the update determining section 111, the image transmitting section 131 transmits, to the display control device 4, image data for update (S310).

The command receiving section 10 of the display control device 4 receives the command from the command generating section 121 (S400, information receiving step), and transmits the command to the process determining section 30. The image receiving section 20 receives the image data for update (S402). The process determining section 30 determines, in accordance with a type of the command received from the command receiving section 10, a process to be carried out by the data processing section 40 (S404). In a case where the command is a through command (“through command” in S404), the process determining section 30 instructs the data processing section 40 to carry out through-output, and an outputting section 41 of the data processing section 40 carries out through-output (S406, data processing step). In a case where the command is a write-and-through command (“write-and-through command” in S404), the process determining section 30 instructs the data processing section 40 to carry out both through-output and writing of the image data in the VRAM 50. In accordance with such an instruction, the outputting section 41 of the data processing section 40 carries out through-output, and the writing section 42 of the data processing section 40 carries out writing of the image data in the VRAM 50 (S408, data processing step).

### Embodiment 3

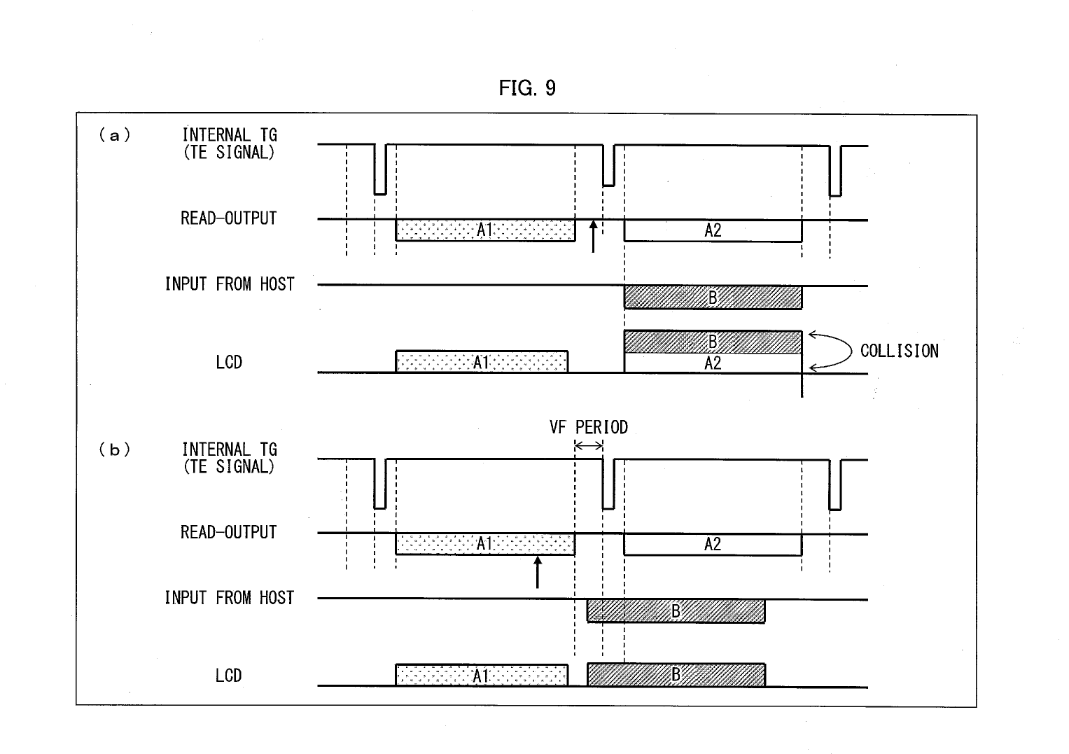

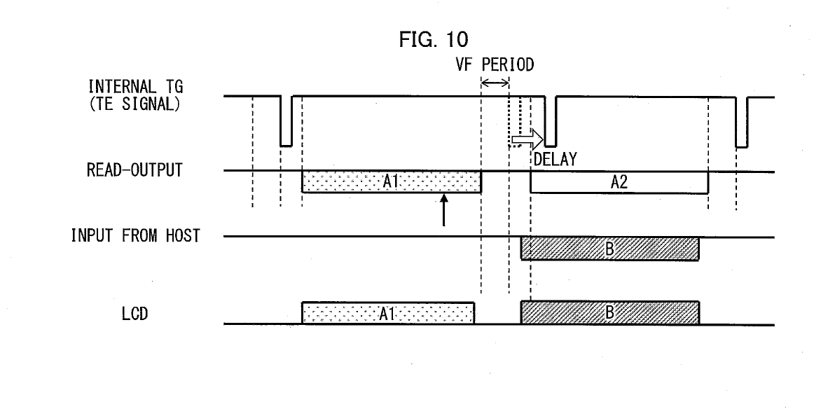

A display control device 1 (or a display control device 4) supplies image data to an LCD 3 by carrying out any one of through-output and read-output. Here, it is assumed that, while the display control device 1 (or the display control device 4) is attempting to carry out read-output of image data in a frame period, the display control device 1 receives a through command and image data from a host 2 (or a host 5). In this case, in the display control device 1, a collision occurs between a through system and a reading system. In order for such a collision between those output systems to be avoided, a command generating section 120 of the host 2 can transmit, to the display control device 1, image data which is scheduled to be outputted in a next frame period, in a VF period of the display control device 1. The following description will discuss, with reference to FIGS. 9 and 10, a process of avoiding a collision between the output systems in accordance with Embodiment 3. FIG. 9 is a timing chart illustrating (i) a vertical sync signal and (ii) timings at which pieces of image data are inputted/outputted, in the display control device 1. (a) of FIG. 9 illustrates a case where a collision can occur between the output systems. (b) of FIG. 9 illustrates an example configuration in which such a collision is avoided. The following description will take, as an example, the display control device 1 and the host 2 in accordance with Embodiment 1. Note, however, that a configuration in accordance with Embodiment 3 is also applicable to Embodiment 2.

An “internal TG” row illustrated in FIG. 9 indicates a fall of a Vsync. A “read-output” row indicates a timing and a period at/during which the display control device 1 is scheduled to carry out read-output. An “input from host” row indicates a timing and a period at/during which image data is transferred (supplied) from the host 2. An “LCD” row indicates a timing and a period at/during which the display control device 1 actually supplies image data to the LCD 3. An arrow illustrated in FIG. 9 indicates a timing at which the display control device 1 receives a through command. As illustrated in (a) of FIG. 9, in a case where (i) the display control device 1 receives a command from the command generating section 120 immediately before the display control device 1 carries out read-output in a next frame period (schedule) or (ii) supply of image data (image data B) from the host 2 to the display control device 1 coincides with a timing at which the display control device 1 carries out read-output (schedule) (A2 in the “read-output” row), a collision occurs between the through-output and the read-output in the display control device 1 (the “LCD” row).

In order for such a collision to be avoided, the host 2 can be arranged so as to transfer (i) a command and (ii) image data for update to be made in a next frame period, earlier than a reading-and-outputting section 60 carries out read-output. More properly, the host 2 preferably transfers image data, for update, in a VF period of a frame period coming immediately before a frame period in which the image data is to be displayed so as to update an image. This is because, since a VF period is a period during which the display control device 1 does not carry out read-output, a collision does not occur in terms of access to a VRAM 50. As has been described in Embodiment 1, the host 2 starts transferring image data after a predetermined delay time from a given edge of a TE signal. Therefore, it is possible to cause the host 2 to start transferring image data in a VF period, by setting a timing of “after a predetermined delay time from a given edge of a TE signal” so that the timing is in the VF period. In this case, it is preferable that, by a start of the VF period, the host 2 supply, to the display control device 1, a through command for a next frame period. This allows a process determining section 30 of the display control device 1 to determine, in accordance with such a command received by the start of the VF period, which one of the output systems the process determining section 30 causes to carry out a process in the next frame period. A data processing section 40 is therefore capable of carrying out through-output of image data for update which image data has been received in the VF period, without causing a collision with read-output carried out by the reading-and-outputting section 60.

Note that, in a case of through-output, the display control device 1 supplies the image data B to the LCD 3 without writing the image data B in the VRAM 50 and, at the same time, the LCD 3 starts outputting the image data B (see the “LCD” row in (b) of FIG. 9). Therefore, through-output of image data is started earlier than read-output of the image data. In such a case, an internal TG 70 of the display control device 1 synchronizes a fall of the Vsync with a time point at which the image data B starts to be received.

Note that the display control device 1 can be arranged such that, in a case where the command receiving section 10 receives a through command, a Vsync of the internal TG 70 is delayed, until the display control device 1 receives image data from the host 2, so that a fall of the Vsync is synchronized with a time point at which the image data starts to be received. FIG. 10 is a timing chart illustrating timings at which pieces of image data are supplied to/from the display control device 1, in a case where the display control device 1 delays outputting a vertical sync signal (Vsync). As illustrated in FIG. 10, in a case where the image data B starts to be supplied from the host 2 to the display control device 1 after an original VF period (supply of the image data B is delayed), the internal TG 70 of the display control device 1 stands by without sending a fall of the Vsync which fall indicates a start of a next frame period (delays the Vsync). Note that, in this case, since the through command itself is transmitted to the display control device 1 before the VF period as illustrated in FIG. 10, the display control device 1 stands by in a state where the reading-and-outputting section 60 does not carry out read-output. Note, here, that, in a case where image data (image data B in FIG. 10) starts to be supplied from the host 2 to the display control device 1 within a given period from a start of supply of image data to the LCD 3 last time, e.g., a period corresponding to 1 (one) cycle of a maximum refresh cycle of the LCD 3 (time period to such a degree that no problem occurs with display of the image data in the LCD 3), the internal TG 70 synchronizes the fall of the Vsync with a timing at which the image data has started to be supplied from the host 2 to the display control device 1. In a case where the image data B is not supplied from the host 2 to the display control device 1 within the given period, the reading-and-outputting section 60 of the display control device 1 carries out read-output so as to supply image data A2 to the LCD 3.

The display control device 1 is thus capable of avoiding a collision between read-output and through-output, even in a case where image data is not supplied to the display control device 1 within a VF period due to, for example, asynchronization with the host 2 or data communication delay.

### Software Implementation Example

A control block of each of the host 2 or 5 and the display control device 1 or 4 (in particular, the update determining section 110, the update determining section 111, and the process determining section 30) can be realized by a logic circuit (hardware) provided in an integrated circuit (IC chip) or the like or can be alternatively realized by software as executed by a central processing unit (CPU).

In the latter case, the display control device 1 includes a CPU that executes instructions of a program that is software realizing the foregoing functions; a read only memory (ROM) or a storage device (each referred to as “storage medium”) in which the program and various kinds of data are stored so as to be readable by a computer (or a CPU); and a random access memory (RAM) in which the program is loaded. An object of the present invention can be achieved by a computer (or a CPU) reading and executing the program stored in the storage medium. Examples of the storage medium encompass “a non-transitory tangible medium” such as a tape, a disk, a card, a semiconductor memory, and a programmable logic circuit. The program can be supplied to the computer via any transmission medium (such as a communication network or a broadcast wave) which allows the program to be transmitted. Note that the present invention can also be achieved in the form of a computer data signal in which the program is embodied via electronic transmission and which is embedded in a carrier wave.

### Summary

A display control device (display control device 1 or 4) in accordance with a first aspect of the present invention is a display control device which receives image data from a host (host 2 or 5) and supplies the image data thus received to a display section (LCD 3), the image data corresponding to (one) frame, the display control device including: an information receiving section (command receiving section 10) which receives, from the host, update information (command) indicative of whether or not the display section is to be caused to update an image displayed by the display section; and a data processing section (data processing section 40) which, in accordance with the update information, at least writes the image data in a memory (VRAM 50) or supplies the image data to the display section, wherein, assuming that any one of a first vertical synchronization period, which is a period in which the display control device receives the image data, and a second vertical synchronization period, which is a period coming next to the first vertical synchronization period, is regarded as a given vertical synchronization period, the data processing section supplies the image data to the display section, without writing the image data in the memory (through-output), in a case where (i) the display control device receives the image data and (ii) the image is to be updated in the given vertical synchronization period, and the data processing section writes the image data in the memory (writing) in a case where (i) the display control device receives the image data and (ii) the image is not to be updated in the given vertical synchronization period.

Note that, more specifically, the first vertical synchronization period indicates a vertical synchronization period in which the display control device finishes receiving image data. According to the above configuration, the data processing section supplies image data to the display section without writing the image data in the memory or writes the image data in the memory, depending on whether or not an image is to be updated in the given vertical synchronization period, that is, a current vertical synchronization period (current frame period) or a vertical synchronization period (next frame period) coming next to the current vertical synchronization period. More specifically, since the data processing section supplies the image data to the display section without writing the image data in the memory in a case where the image is to be updated, it is possible to reduce electric power necessary to write the image data in the memory. Furthermore, in a case where the image is not to be updated, the data processing section once writes the image data in the memory. Accordingly, in a case where image data needs to be supplied to the display section so that the display section carries out refresh or the like, it is possible to read out the image data written in the memory without a necessity for the host to re-transmit the image data each time the display section carries out refresh or the like. Therefore, it is possible to reduce electric power necessary to receive the image data. As such, according to the display control device, it is possible to suppress electric power consumed in display of the image data in the display section.

The display control device (display control device 1) in accordance with a second aspect of the present invention can be arranged such that, in the first aspect, the given vertical synchronization period is the first vertical synchronization period.

According to the above configuration, in a case where an image is to be updated in the current vertical synchronization period (current frame period) in which the display control device has received image data, the data processing section supplies the image data to the display section without writing the image data in the memory. Therefore, according to the display control device, it is possible to suppress electric power necessary to, in particular, write the image data in the memory.

The display control device in accordance with a third aspect of the present invention can be arranged such that, in the second aspect, in a case where the image is not to be updated for a given period after the data processing section supplies the image data to the display section, the data processing section writes, in the memory, the image data which has been re-transmitted from the host (transmitted image data).

According to the above configuration, in a case where an image is not to be updated for a given period, the data processing section re-receives image data from the host and writes the image data in the memory. Note, here, that the “given period” indicates, for example, an interval between refreshes of the display section. With this, in a case where, for example, a frequency of update of the image is decreased, the display control device does not need to receive image data from the host each time the display section carries out refresh. Therefore, according to the display control device, it is possible to reduce electric power consumed in receipt of the image data.

The display control device (display control device 4) in accordance with a fourth aspect of the present invention can be arranged such that, in the first aspect, the given vertical synchronization period is the second vertical synchronization period.

According to the above configuration, in a case where an image is to be updated in a vertical synchronization period (next frame period) coming next to the current vertical synchronization period (current frame period) in which the display control device has received image data, the data processing section supplies the image data to the display section without writing the image data in the memory.

Note, here, that the fact that the image is to be updated in the next frame period means that the image data which the display control device has received in the current frame period is not used later for refresh of the display section. Therefore, by the data processing section supplying the image data, which is not used for refresh as described above, to the display section without writing the image data in the memory, it is possible to decrease a frequency of writing unnecessary data in the memory. Therefore, according to the display control device, it is possible to reduce electric power consumed in writing of data in the memory.

The display control device in accordance with a fifth aspect of the present invention can be arranged such that, in the fourth aspect, in a case where (i) the image is not to be updated in the second vertical synchronization period and (ii) the image is to be updated in the first vertical synchronization period, the data processing section writes the image data in the memory and supplies the image data to the display section.

According to the above configuration, in a case where an image is not to be updated from the next frame period (at least 1 (one) frame period), the data processing section can supply image data to the display section and write the image data in the memory in preparation for refresh of the display section.

The display control device in accordance with a sixth aspect of the present invention can be arranged so as to further include, in any one of the first through fifth aspects, a reading-and-outputting section (reading-and-outputting section 60) which reads out the image data from the memory and supplies the image data to the display section in a case where a given time elapses without update of the image after the data processing section supplies the image data to the display section.

According to the above configuration, in a case where image data needs to be periodically supplied to the display section so that the display section carries out refresh, the display control device does not need to receive the image data from the host each time the display section carries out refresh. Instead, the reading-and-outputting section reads out the image data written in the memory, and supplies the image data to the display section. This allows the display section to carry out refresh. Therefore, according to the display control device, it is possible to reduce electric power consumed in receipt of the image data.

The display control device in accordance with a seventh aspect of the present invention can be arranged such that, in the sixth aspect, in a vertical front porch period of the first vertical synchronization period, the data processing section starts receiving the image data transmitted from the host and supplying the image data to the display section.

According to the above configuration, in the vertical front porch period in which no image data is read out from the memory, the data processing section starts receiving image data transmitted from the host and supplying the image data to the display section. Therefore, according to the data processing section, it is possible to prevent a collision between (i) output of the image data which output is carried out by the data processing section and (ii) output of image data read out from the memory which output is carried out by the reading-and-outputting section.

The display control device in accordance with an eighth aspect of the present invention can be arranged such that, in the seventh aspect, the data processing section receives the update information by a start of the vertical front porch period of the first vertical synchronization period.

According to the above configuration, the data processing section can receive update information before receiving image data. This makes it possible to determine, in advance, whether or not to cause the data processing section to supply the image data without writing the image data in the memory, before the display control device receives the image data. With this, according to the display control device, it is possible to determine whether to cause (i) the data processing section to output the image data so that an image displayed by the display section is to be updated or (ii) the reading-and-outputting section to output image data so that the display section carries out refresh, by a timing at which the display control device receives the image data and by a timing at which the display control device supplies the image data to the display section. Therefore, it is possible to prevent a collision between (i) output of the image data which output is carried out by the data processing section and (ii) output of the image data (image data written in the memory) which output is carried out by the reading-and-outputting section.

The display control device in accordance with a ninth aspect of the present invention can be arranged so as to further include, in the seventh or eighth aspect, a timing determining section (internal TG 70) which determines a timing at which the image data is supplied to the display section, the timing determining section delaying, until the display control device receives the image data, a timing at which the display section is driven, in a case where the image is to be updated in the first vertical synchronization period.

According to the above configuration, in a case where the display control device cannot start receiving image data within the vertical front porch period due to, for example, asynchronization with the host or delay of receipt of the image data, the timing determining section delays a timing at which the display control device supplies the image data to the display section, until the display control device receives the image data. This makes it possible to postpone determination of whether to cause (i) the data processing section to output the image data so that an image displayed by the display section is to be updated or (ii) the reading-and-outputting section to output image data so that the display section carries out refresh. Therefore, according to the display control device, even in a case where the display control device cannot start receiving image data within the vertical front porch period, it is possible to prevent a collision between (i) output of the image data which output is carried out by the data processing section and (ii) output of the image data (image data written in the memory) which output is carried out by the reading-and-outputting section.

A display device (display device 500 or 600) in accordance with a tenth aspect of the present invention is a display device including a display control device (display control device 1 or 4) recited in any one of the first through ninth aspects.

According to the above configuration, the display device brings about effects similar to those brought about by the display control device recited in any one of the first through ninth aspects.

A display control method in accordance with an eleventh aspect of the present invention is a display control method carried out by a display control device (display control device 1 or 4) which receives image data from a host (host 2 or 5) and supplies the image data thus received to a display section (LCD 3), the image data corresponding to 1 (one) frame, the method including: an information receiving step (S200 or S400) of receiving, from the host, update information (command) indicative of whether or not the display section is to be caused to update an image displayed by the display section; and a data processing step (S206 to S208 or S406 to S408) of, in accordance with the update information received in the information receiving step, at least writing the image data in a memory or supplying the image data to the display section, wherein, assuming that any one of a first vertical synchronization period, which is a period in which the display control device receives the image data, and a second vertical synchronization period, which is a period coming next to the first vertical synchronization period, is regarded as a given vertical synchronization period, in the data processing step, the image data is supplied to the display section, without being written in the memory, (through-output) in a case where (i) the display control device receives the image data and (ii) the image is to be updated in the given vertical synchronization period, and the image data is written in the memory (writing) in a case where (i) the display control device receives the image data and (ii) the image is not to be updated in the given vertical synchronization period.

According to the above configuration, the display control method brings about effects similar to those brought about by the display control device in accordance with the first aspect.

The present invention is not limited to the embodiments, but can be altered by a skilled person in the art within the scope of the claims. An embodiment derived from a proper combination of technical means each disclosed in a different embodiment is also encompassed in the technical scope of the present invention. Further, it is possible to form a new technical feature by combining the technical means disclosed in the respective embodiments.

### INDUSTRIAL APPLICABILITY

The present invention is applicable to a display control device which is included in a display device, such as a mobile phone and a personal computer, including a display section. In particular, the present invention is suitably applicable to a display control device which carries out display control with respect to a display section that can change a drive frequency.

### REFERENCE SIGNS LIST

500, 600 Display device

1, 4 Display control device

2, 5 Host

3 LCD (display section)

10 Command receiving section (information receiving section)

20 Image receiving section

30 Process determining section

40 Data processing section

50 VRAM (memory)

60 Reading-and-outputting section

70 Internal TG (timing determining section)

100 Update request obtaining section

110, 111 Update determining section

120, 121 Command generating section

130, 131 Image transmitting section

140 Update information buffer

1. A display control device which receives image data from a host and supplies the image data thus received to a display section, the image data corresponding to 1 (one) frame,
the display control device comprising:
an information receiving section which receives, from the host, update information indicative of whether or not the display section is to be caused to update an image displayed by the display section; and
a data processing section which, in accordance with the update information, at least writes the image data in a memory or supplies the image data to the display section,
wherein, assuming that any one of a first vertical synchronization period, which is a period in which the display control device receives the image data, and a second vertical synchronization period, which is a period coming next to the first vertical synchronization period, is regarded as a given vertical synchronization period,
the data processing section supplies the image data to the display section, without writing the image data in the memory, in a case where (i) the display control device receives the image data and (ii) the image is to be updated in the given vertical synchronization period, and
the data processing section writes the image data in the memory in a case where (i) the display control device receives the image data and (ii) the image is not to be updated in the given vertical synchronization period.

2. The display control device as set forth in claim 1, wherein the given vertical synchronization period is the first vertical synchronization period.

3. The display control device as set forth in claim 2, wherein, in a case where the image is not to be updated for a given period after the data processing section supplies the image data to the display section, the data processing section writes, in the memory, the image data which has been re-transmitted from the host.

4. The display control device as set forth in claim 1, wherein the given vertical synchronization period is the second vertical synchronization period.

5. The display control device as set forth in claim 4, wherein, in a case where (i) the image is not to be updated in the second vertical synchronization period and (ii) the image is to be updated in the first vertical synchronization period, the data processing section writes the image data in the memory and supplies the image data to the display section.

6. A display control device as set forth in claims 1, further comprising a reading-and-outputting section which reads out the image data from the memory and supplies the image data to the display section in a case where a given time elapses without update of the image after the data processing section supplies the image data to the display section.

7. The display control device as set forth in claim 6, wherein, in a vertical front porch period of the first vertical synchronization period, the data processing section starts receiving the image data transmitted from the host and supplying the image data to the display section.

8. The display control device as set forth in claim 7, wherein the information receiving section receives the update information by a start of the vertical front porch period of the first vertical synchronization period.

9. A display control device as set forth in claim 7, further comprising a timing determining section which determines a timing at which the image data is supplied to the display section, the timing determining section delaying, until the display control device receives the image data, a timing at which the display section is driven, in a case where the image is to be updated in the first vertical synchronization period.

10. A display device comprising a display control device recited in claim 1.

11. A display control method carried out by a display control device which receives image data from a host and supplies the image data thus received to a display section, the image data corresponding to 1 (one) frame,
the method comprising:
an information receiving step of receiving, from the host, update information indicative of whether or not the display section is to be caused to update an image displayed by the display section; and
a data processing step of, in accordance with the update information received in the information receiving step, at least writing the image data in a memory or supplying the image data to the display section,
wherein, assuming that any one of a first vertical synchronization period, which is a period in which the display control device receives the image data, and a second vertical synchronization period, which is a period coming next to the first vertical synchronization period, is regarded as a given vertical synchronization period,
in the data processing step, the image data is supplied to the display section, without being written in the memory, in a case where (i) the display control device receives the image data and (ii) the image is to be updated in the given vertical synchronization period, and
the image data is written in the memory in a case where (i) the display control device receives the image data and (ii) the image is not to be updated in the given vertical synchronization period.
